(19) United States
(12) Patent Application Publication
(10) Pub. No.: US 2007/0293136 A1
(43) Pub. Date: Dec. 20, 2007

(54) Cooling and safety apparatus for occupants of golf carts

(76) Inventor: Robert A. Hancock, Ocala, FL (US)

Correspondence Address: Douglas Wm. Massinger, Esq.;Massinger Law Offices, 887 N.E. 100 Street, Ocala, FL, 34479, US

(21) Appl. No.: 11/454,351

(22) Filed: Jun. 16, 2006

(51) Int. Cl. B60H 1/00

(52) U.S. Cl. 454/143

(57) ABSTRACT

A cooling and safety apparatus for golf carts is comprised of three primary components, namely an elongate fan support assembly, driver and passenger fan assemblies, and apparatus mounting means. Fans mounted substantially within fan support assembly are removably secured to the underside of a golf cart canopy via apparatus mounting means and activated to provide a downward current of forced air having a velocity sufficient to divert airborne matter away from the head, neck and face of vehicle occupants.

### FIELD OF THE INVENTION

The subject invention relates to golf carts generally, and to an apparatus for cooling the occupants of golf carts as well as protecting them from airborne particulate matter in particular.

### BACKGROUND OF THE INVENTION

Golf carts and other slow moving open-air vehicles provide a desirable experience for their occupants, particularly during temperate weather conditions. Unfortunately, this enjoyable experience is often impeded by extremely high temperatures, the effects of which are magnified when the occupant is involved in physical activity such as, for instance, the playing of golf. Moreover, the pleasurable experience of riding in such open-air vehicles is diminished by exposure to flying insects, falling leaves, and other airborne debris. Such airborne matter serves as an irritant to vehicle occupants, often entering their nose, eyes or mouth, or otherwise impacting their head, neck and face.

In order that occupants may be protected from precipitation and airborne matter approaching from the direction of vehicle travel, many golf carts are fitted with a windshield mounted in front of the passenger compartment. The drawback to using a golf cart with a windshield is that, while shielding the occupants from wind, weather, and debris intrusion, the windshield blocks all airflow from the forward direction. While safer, the golfers' pleasurable experience of feeling the breeze as they drive is precluded by the windshield. There have been some devices that allow some airflow through the windshield area while inhibiting entry of airborne foreign objects. These devices have generally been relatively ineffective and obtrusive in appearance, or otherwise are incapable of protecting the vehicle occupants from such airborne matter entering the vehicle compartment from directions other than through the windshield area.

Accordingly, there is a need for a golf cart accessory device capable of simultaneously: a) permitting air to flow through the windshield area to cool the occupants, b) providing mechanically induced air current to the head and body of occupants for cooling purposes, and c) diverting airborne foreign matter away from the head, neck and face of vehicle occupants. To this end, there is a need for an easily retrofitted assembly that can accomplish these objectives which can be installed in a simple manner that does not affect the overall appearance of the golf cart or inhibit head room within the seating compartment.

### SUMMARY OF THE INVENTION

In accordance with the teachings of the subject invention a cooling and safety apparatus for golf carts is comprised of three primary components, namely an elongate fan support assembly, driver and passenger fan assemblies, and apparatus mounting means. Fans mounted substantially within fan support assembly are removably secured to the underside of a golf cart canopy such that they are each capable of providing a downward current of forced air having a velocity sufficient to divert airborne matter away from the head, neck and face of vehicle occupants. In another embodiment of the invention, only one fan is housed within the fan support assembly. The subject apparatus has a low-profile and therefore does not substantially interfere with head room within the golf cart.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a portable cooling and safety apparatus for golf carts and other open-air slow moving vehicles capable of providing a cooling effect to the head and body of vehicle occupants as well as a downward current of forced air capable of diverting airborne matter which would otherwise impact the head, neck or face of the vehicle occupants.

Another object of the subject invention is to provide a cooling and safety apparatus for golf carts which is susceptible of a low cost of manufacture with regard to both materials and labor, and which accordingly is then susceptible of low prices of sale to the consuming public, thereby making the device available to a broad range of the buying public.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side view of typical golf cart having the subject cooling and safety apparatus mounted thereto;

FIG. 2 is plan view of the golf cart of FIG. 1, portions of which are illustrated in phantom view to better reveal positioning of the subject invention relative to the cart's occupants;

FIG. 3 is a bottom view of the subject cooling and safety apparatus for golf carts;

FIG. 4 is a plan view of the invention of FIG. 3; and

FIG. 5 is a perspective view of the subject cooling and safety apparatus shown mounted on the canopy of a golf cart.

### DETAILED DESCRIPTION OF THE PREFERRED EMBODIMENT

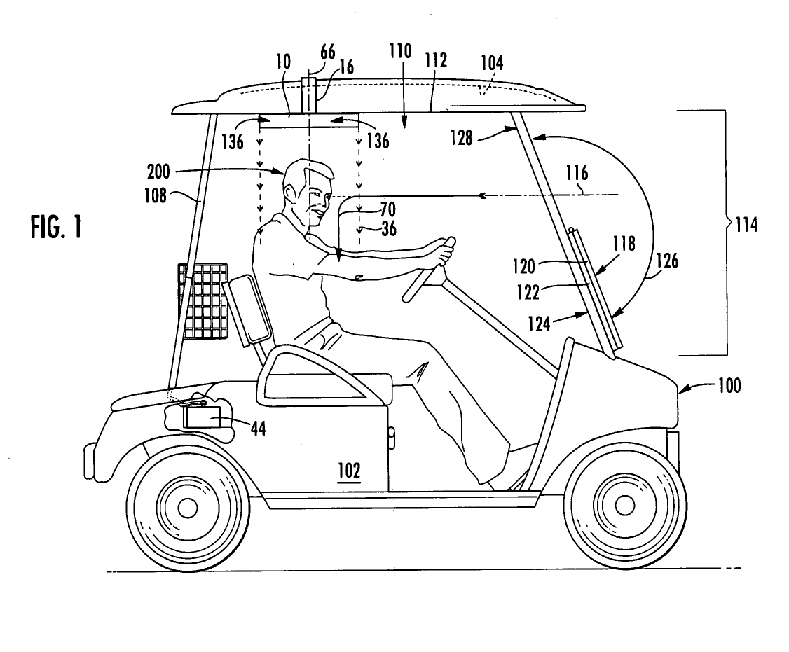

Reference is now made to FIG. 1 in which there is illustrated a side view of the subject cooling and safety apparatus (hereinafter sometimes also referred to simply as “safety apparatus”), designated generally by reference numeral 10, shown mounted on a typical golf cart 100. It should be appreciated at the outset that the subject invention is not limited to use in golf carts only, but may also be employed in any slow moving recreational, utility or construction vehicle having an overhead roof or canopy and an open-air driving compartment. The golf cart 100 described herein is merely illustrative.

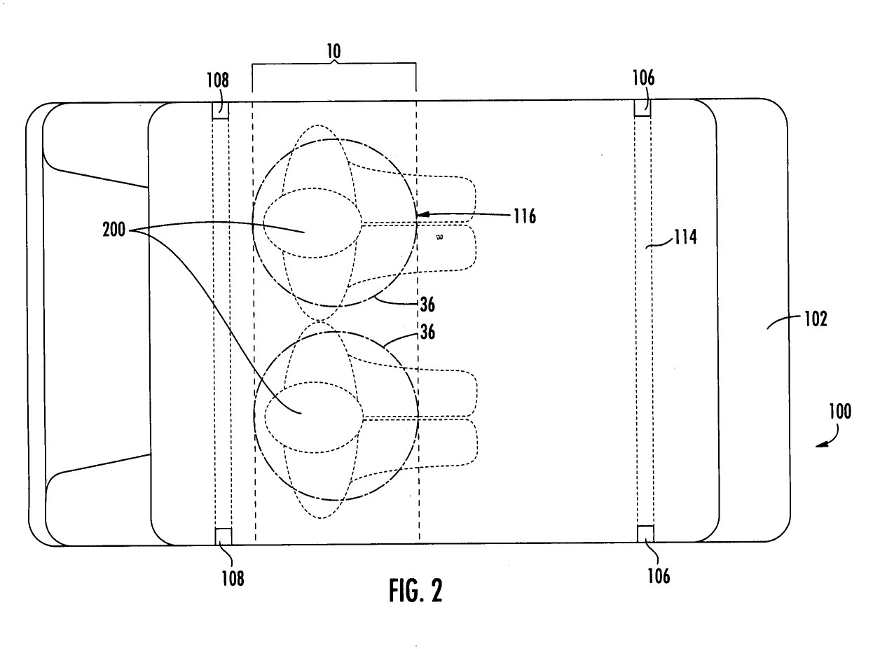

With continued reference to FIG. 1, golf cart 100 includes a body 102 that houses a motor (not shown) which is typically electric or gas powered, a rigid roof structure or canopy 104 above said body 102, a pair front canopy support members 106, and a pair of rear canopy support members 108. Together, body 102, canopy 104, and front and rear canopy support members 106 and 108, respectively, define driver/passenger compartment 110 which is emphasized using bold outline 112. As best seen in FIG. 2, front support members 106, canopy 104 and body 102 define windshield area 114 through which air can flow into compartment 110, particularly during forward movement of golf cart 100, as illustrated by air flow directional arrow 116.

As will readily be appreciated by those familiar with operating or riding as a passenger in a golf cart, the pleasant experience of being in an open-air compartment is unfortunately attendant with exposure to undesirable airborne matter such as flying insects, falling leaves, dust and other airborne particles. Such airborne matter is a constant irritant to vehicle occupants 200 often entering their noses and mouths, or in more serious situations impacting and causing injury to their eyes.

In an effort to protect vehicle occupants 200 from coming into contact with airborne matter, or visa versa, most golf carts are equipped with a windshield assembly 118 which is either a single panel of transparent and shatter resistant polymer material occupying the majority of windshield area 114 or, more commonly, a fixed panel 120 and a movable panel 122 hingedly attached to one another. Fixed panel 120 is mounted to the lower portion 124 of front canopy support member 106. Moveable panel 122 may be selectively rotated along arced path 126 to a raised closed position abutting the upper portion 128 of front canopy support member 106, or to a lowered open position abutting fixed panel 120 as shown. When raised to its closed position, moveable panel 122 serves to shield vehicle occupants 200 of golf cart 100 from wind, weather, and airborne foreign matter. As previously mentioned, a drawback to positioning moveable panel 122 in an upright closed position is that, although shielding vehicle occupants 200 from such outside elements, it also blocks desirable airflow from the forward direction. While safer, the occupants' pleasurable experience of feeling the breeze as they drive is prevented.

In order that vehicle occupants 200 may simultaneously enjoy the cooling benefits of airflow along first airflow directional path 116 together with the protective benefits afforded by a raised windshield, the subject cooling and safety apparatus 10 is employed as herein described in detail. It should first be appreciated that the subject apparatus provides both comfort and safety advantages to vehicle occupants regardless of whether windshield assembly 118 is in an open or closed configuration and, in fact, whether golf cart 100 is equipped with a windshield at all.

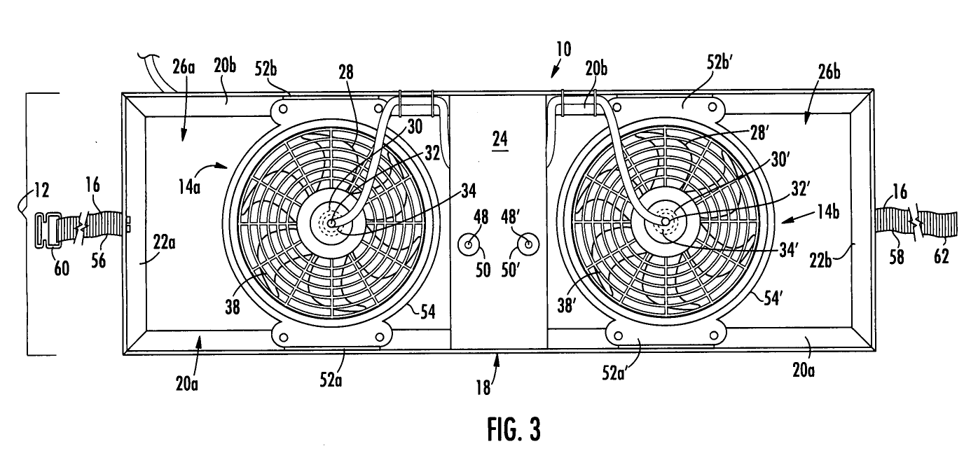

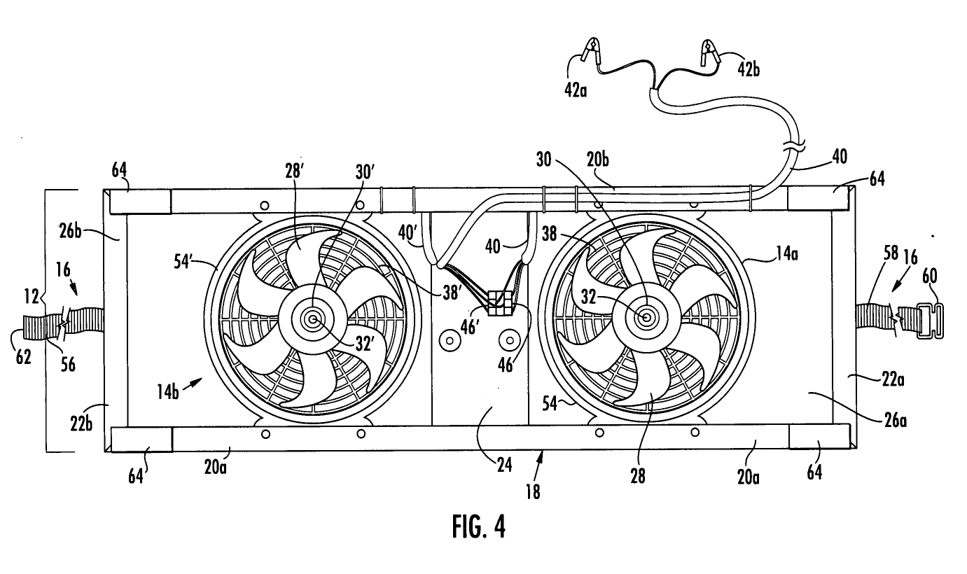

Reference now being made to FIGS. 3 and 4, a preferred embodiment of the subject invention is comprised of three primary components, namely an elongate fan support assembly 12, driver and passenger fan assemblies 14a and 14b, and mounting means 16. Fan support assembly 12 is comprised of perimeter frame 18 which is preferably, but not essentially, rectangular in shape. Fan support assembly includes first and second transverse side members 20a and 20b which are oriented parallel to one another and in a preferred embodiment each having a length no less than the width of canopy 104. A first side frame member 22a is fixedly mounted between first and second transverse side members 20a and 20b, preferably at their ends. Similarly, a second side frame member 22b is fixedly mounted between first and second transverse side members 20a and 20b, preferably at their ends. First and second side frame members 22a and 22b, therefore, are parallel to one another, are perpendicular to transverse side members 20a and 20b, and serve to bridge the space there between. First and second side frame members 22a,b may be of a variety of lengths provided said length is greater than the diameter of driver and passenger fan assemblies 14a,b. Perimeter frame 18 is preferably, but not essentially constructed of 1″×1″ aluminum angle which is L-shaped in cross-section.

A switch panel 24 is bridged between transverse side members 20a,b in perpendicular orientation. More specifically, a first end of switch panel 24 is fixedly connected to a point along the length of first transverse frame member 20a, said point being preferably at its midpoint; the opposite end of switch panel 24 is fixedly connected to a point along the length of second transverse frame member 20b, said point being preferably at its midpoint. Switch panel 24 is also preferably, but not essentially rectangular in shape and planar in cross-section. A first area 26a is defined by switch panel 24, first side frame member 22a, and transverse frame members 20a,b and substantially houses driver fan assembly 14a. A second area 26b is defined by switch panel 24, second side frame member 22b, and transverse frame members 20a,b and substantially houses passenger fan assembly 14b. Those portions of first and second areas 26a and 26b which are not occupied by corresponding driver and passenger fan assemblies 14a and 14b may be open (a void) or solid.

With continued reference to FIGS. 3 and 4, driver fan assembly 14a includes a fan having a series of incrementally spaced vanes 28 radiating from a hub 30 which is rotated on its axle 32 by a motor 34 to produce a current of air 36 represented by the shaded area depicted in FIGS. 1, 2 and 5. Fan assembly 14a further includes safety grill 38 to protect vehicle occupants from rotating vanes 28. Fan power means are comprised of power cord 40 attached at one end to motor 34 and at its opposite end to metallic alligator clips 42a,b which are connected to the terminals of battery 44 of golf cart 100 (FIG. 1). Fan assembly 14a further includes switch 46 connected to power cord 40 intermediate fan motor 34 and clips 42a,b. Switch assembly is mounted to a first side of switch panel 24 (FIG. 4) and includes a toggle 48 disposed through aperture 50 of switch panel 24. Toggle 48 may be selectively adjusted to low, high and off settings of fan assembly 14a.

Passenger fan assembly 14b includes a fan having a series of incrementally spaced vanes 28′ radiating from a hub 30′ which is rotated on its axle 32′ by a motor 34′ to produce a current of air 36′ represented by the shaded area depicted in FIGS. 1, 2 and 5. Fan assembly 14b further includes safety grill 38′ to protect vehicle occupants from rotating vanes 28′. Power cord 40′ is attached at one end to motor 34′ and at its opposite end to metallic alligator clips 42a,b which are connected to the terminals of battery 44 of golf cart 100 (FIG. 1). Fan assembly 14b further includes switch 46′ connected to power cord 40′ intermediate fan motor 34′ and clips 42a,b. Switch assembly is mounted to a first side of switch panel 24 (FIG. 4) and includes a toggle 48′ disposed through aperture 50′ of switch panel 24 (FIG. 3). Toggle 48′ may be selectively adjusted to low, high and off settings of fan assembly 14b.

A first fan mounting bracket 52a is fixedly mounted to transverse frame member 20a between side frame member 22a and switch panel 24, and extends into first area 26a. A second fan mounting bracket 52b is fixedly mounted to transverse frame member 20b and extends into first area 26a opposite first fan mounting bracket 52a. The inwardly extending portion of both first and second fan mounting brackets 52a,b are concaved for cooperative and fixed abutment with portions of the outer circumference 54 of first fan assembly 14a using threaded fasteners or other suitable attachment means.

A third fan mounting bracket 52a′ is fixedly mounted to transverse frame member 20a between side frame member 22b and switch panel 24, and extends into second area 26b. A fourth fan mounting bracket 52b′ is fixedly mounted to transverse frame member 20b and extends into second area 26b opposite third fan mounting bracket 52a′. The inwardly extending portion of both third and fourth fan mounting brackets 52a′,b′ are concaved for cooperative and fixed abutment with portions of the outer circumference 54′ of second fan assembly 14b using threaded fasteners or other suitable attachment means.

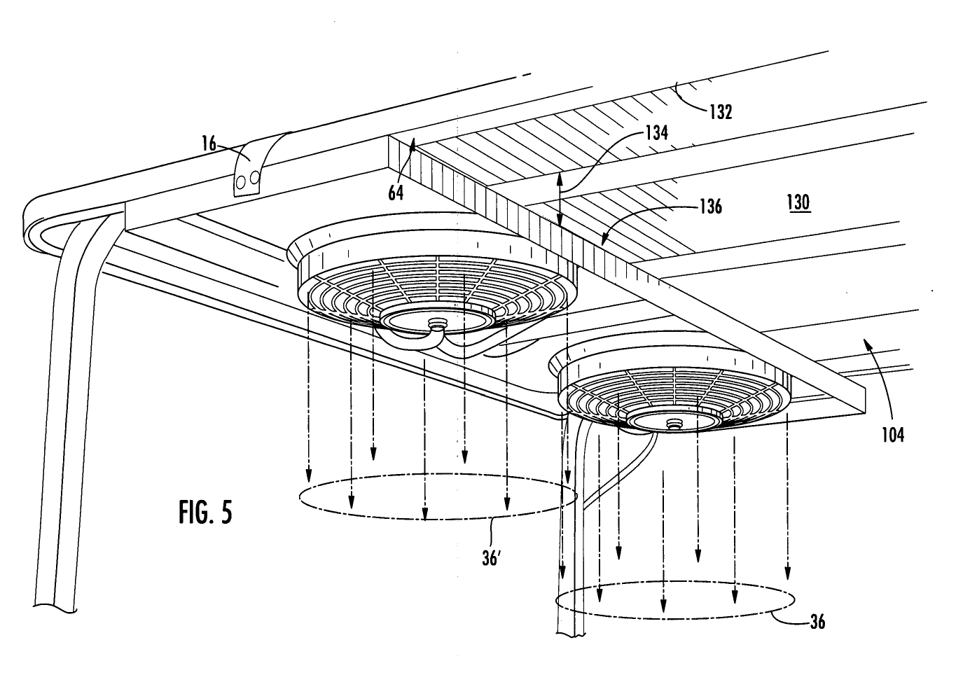

An important feature of the subject invention is the low-profile design of fan support assembly 12 and the driver and passenger fan assemblies 14a,b mounted therein. With a combined height of less than or equal to 2.5 inches, the subject cooling and safety apparatus may be mounted beneath the canopy of golf carts (FIGS. 1 and 5) without compromising significant head room. Mounting means 16 are employed to accomplish removable mounting of fan support assembly 12 to the underside 130 of canopy 104. Note that canopy 104 is dome-shaped in cross-section which such shape permits engagement of transverse frame members 20a,b with the outer edge 132 of the canopy while leaving airspace 134 above fan support assembly 12 for the unimpeded flow of ambient air into and through fan assemblies 14a,b as represented by airflow directional arrows 136.

Referring to FIGS. 3 and 4, in the embodiment illustrated, mounting means 16 are comprised of first strap 56, second strap 58 and strap connection means 60. A first end of first strap 56 is fixedly mounted to side frame member 22a and terminates at its free end in strap connection means 60 which in this case is a buckle. Similarly, a first end of second strap 58 is fixedly mounted to side frame member 22b and terminates in free end 62. Mounting of the subject apparatus to the underside 130 of canopy 104 is accomplished by extending second strap 58 over canopy 104 and threading its free end through the buckle for tightening in the conventional way. Note that the combined length of first strap 56 and second strap 58 must be greater than the width of canopy 104 of golf cart 100 to function properly. Shock absorbing means 64 may be optionally affixed to those portions of transverse frame members 20a,b which are in abutting engagement with canopy edge 132 to reduce shaking and provide improved communication there between.

Referring now to FIG. 5, it should be understood that the positioning of the subject cooling and safety apparatus generally, and driver and passenger fan assemblies 14a,b in particular, relative to the underlying vehicle occupants 200 is critical to achieving the maximum benefits thereof. As a general rule, cooling and safety apparatus 10 should be mounted beneath canopy 104 of golf cart 100 and above the driver and passenger seating areas as defined by the cart's bench seat. More specifically, the axis of rotation 66 of driver fan assembly 14a about its axle 32 intersects in a substantially perpendicular fashion the driver seat area of the cart (FIG. 1). Similarly, the axis of rotation 66′ of passenger fan assembly 14b about its axle 32′ intersects in substantially perpendicular fashion the passenger seat area of the cart. Such positioning creates a cooling and protective zone around both driver and passenger as represented by shaded area 36 in FIGS. 1 and 2 and defined by the area below the diameter of each fan. When driver and/or passenger fans are activated, a downward current of air 36 is produced in the corresponding shaded areas of FIG. 2. Not only does this current of air provide a cooling effect to the head and body of vehicle occupants 200, but it also provides a downward current of forced air capable of diverting airborne matter which would otherwise impact the head, neck or face of the vehicle occupants. By way of example, when an airborne particle traveling along path 116 enters the protective zone 36 of the driver, it is deflected downward along arced path 70 away from the driver's face. It should be appreciated that vehicle occupants 200 are substantially protected from such airborne matter regardless of its direction of travel into protective zone 36. Fans capable of producing greater air current velocities will, of course, possess greater diversion capability.

It should be readily appreciated that other embodiments of the heretofore described cooling and safety apparatus may be employed such as a single fan assembly unit situate over only one occupant, or a larger diameter fan assembly unit capable of cooling and protecting two occupants simultaneously. Still other embodiments may employ multiple fan units may be employed rather than the preferred two fan arrangement

Although the present invention has been described with reference to the particular embodiments herein set forth, it is understood that the present disclosure has been made only by way of example and that numerous changes in details of construction may, be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of: the United States is as follows:

1. A portable cooling and safety apparatus for golf carts, comprising:
a. at least one fan mounted to a fan support assembly;
b. mounting means fixedly attached to said fan support assembly for the removable mounting thereof to the underside of a golf cart canopy; and
c. fan power means connected intermediate said at least one fan and a battery housed within the golf cart,
whereby said cooling apparatus may be mounted above golf cart occupants and activated to produce a downward current of forced air having a velocity sufficient to divert airborne matter away from an occupant's head, neck and face.

2. A portable cooling and safety apparatus for golf carts, comprising:
a. a fan support assembly removably mounted to the underside of the golf cart canopy;
b. a first fan mounted to said fan support assembly, said first fan having an axis of rotation above the driver seat area of the cart;
c. a second fan mounted to said fan support assembly, said second fan having an axis of rotation above the passenger seat area of the cart; and
d. fan power means connected intermediate said first fan and said second fan on the one hand, and a battery housed within the golf cart on the other hand,
whereby said cooling apparatus may be activated to produce a downward current of forced air having a velocity sufficient to divert airborne matter away from an occupant's head, neck and face.

3. A method of creating a current of forced air extending down onto the head of at least one golf cart occupant, the method comprising the steps of:
a. mounting a fan support assembly to the underside of a golf cart canopy, said fan support assembly having at least one fan fixedly mounted thereto, said at least one fan having an axis of rotation which intersects the seating area of either the driver seating area or passenger seating area of the golf cart;
b. connecting fan power means between said fan and a battery housed within the golf cart; and
c. activating said fan.

4. The portable cooling and safety apparatus for golf carts of claim 1, wherein said fan support assembly has a width no less than the width of the golf cart canopy.

5. The portable cooling and safety apparatus for golf carts of claim 2, wherein said fan support assembly has a width no less than the width of the golf cart canopy.

6. The method of creating a current of forced air extending down onto the head of at least one golf cart occupant of claim 3, wherein said fan support assembly has a width no less than the width of the golf cart canopy.

7. The portable cooling and safety apparatus for golf carts of claim 1, wherein said fan support assembly has a height of no greater than 2.5 inches.

8. The portable cooling and safety apparatus for golf carts of claim 2, wherein said fan support assembly has a height of no greater than 2.5 inches.

9. The method of creating a current of forced air extending down onto the head of at least one golf cart occupant of claim 3, wherein said fan support assembly has a height of no greater than 2.5 inches.

10. The portable cooling and safety apparatus for golf carts of claim 1, wherein said fan produces a downward current of forced air having a velocity sufficient to divert airborne matter away from an occupant's head, neck and face.

11. The portable cooling and safety apparatus for golf carts of claim 2, wherein said fan produces a downward current of forced air having a velocity sufficient to divert airborne matter away from an occupant's head, neck and face.

12. The method of creating a current of forced air extending down onto the head of at least one golf cart occupant of claim 3, wherein said fan produces a downward current of forced air having a velocity sufficient to divert airborne matter away from an occupant's head, neck and face.
